(19) United States
(12) Patent Application Publication
(10) Pub. No.: US 2002/0124642 A1
(43) Pub. Date: Sep. 12, 2002

(54) Drum stik

(76) Inventor: William J. Bugg, La Habra, CA (US)

Correspondence Address: EnviroTime, Inc., c/o William J. Bugg, 1100 D. Los Lomas Drive, La Habra, CA, 90631, US

(21) Appl. No.: 09/802,009

(22) Filed: Mar. 9, 2001

(51) Int. Cl. G01F 23/00

(52) U.S. Cl. 73/290 B; 73/290 R

(57) ABSTRACT

EnviroTime, Inc. (sole inventor: William J. Bugg) is disclosing a new invention called, “The Drum Stik”. This invention is an original, unique tool to adequately measure the amount of liquid material in a 30 or 55-gallon drum. This product is a cost saving solution for waste hauler, waste generators, and environmental professionals. This invention is a specialty product with unique features. The product is to provide hazardous and non-hazardous waste generators a tool for accurately measuring the amount of liquid waste prior to shipment offsite. The hole in the handle of “The Drum Stik” is so the customer can slide a rag through the end of the stick and wipe off the residual oil or liquid that accumulates on the stick during the measuring process.

The height of the liquid in the drum is captured in the notches on the stick. Therefore, the level of the liquid can be read off of the notch on the stick. The notches are specifically calculated to coordinate with the typical dimensions of a standard 30-gallon and 55-gallon hazardous waste drums. Prior to a shipment of waste offsite for disposal, a generator can take more precise measurements, instead of relying on the waste hauler to estimate the volume of liquid waste. Depending on the types of hazardous or non-hazardous material that is being measured, this product comes in two different materials: metal and plastic sticks. The plastic stick will be chemically treated for different types of acids and caustic materials. The metal stick version will be for primarily oils and other petroleum based materials.

This product is a cost saving solution for all users and customers. We are protecting the unique design and utility under a patent application.

### CROSS-REFERENCE TO RELATED APPLICATIONS

Not applicable

Applicant is not aware at this time of any related patent applications.

### STATEMENT REGARDING FEDERALLY SPONSORED RESEARCH OR DEVELOPMENT

Not applicable

This invention is not granted under a federally sponsored research and development project.

### REFERENCE TO A MICROFICHE APPENDIX

Not applicable

Microfiche is not included in the application.

### BACKGROUND OF INVENTION

Proposed Design Dimensions:

Stick: 1½ inches wide×1/2 inch thick×37½ inches long

Handle: 3½ inches wide×1/2 inch thick×7 inches long

Material: Plastic or Metal

(Note: Please refer to the attached drawings for more details)

EnviroTime, Inc. (c/o William J. Bugg) invented “The Drum Stik” to help improve the accurately reporting of liquid wastes or oil sent offsite for disposal and recycling.

It is very difficult to estimate the amount of liquid waste or oil that is in a drum prior to the shipment offsite for recycling or disposal. This original design was specifically manufactured to aide environmental and safety professionals and waste haulers for accurately collecting the measurements of waste liquids in a drum.

The concept is very similar to a “dip stick” in your automobile; however, this original design is specifically for larger containers and hazardous waste drums. This tool (measuring stick) is made of metal or plastic with grooves on the side of the stick for determining the quantity of liquid in a drum.

### BRIEF SUMMARY OF THE INVENTION

“The Drum Stik” was designed to assist environmental professionals and hazardous waste operators with the accurate measuring of used oils and hazardous waste liquids. Prior to disposing of waste liquids, a generator of hazardous waste will be able to measure the liquid wastes. Also, hazardous waste haulers will be able to measure the waste liquids to ensure they are accurately charging their customers for the disposal of waste liquids. This tool will be a cost saving to all that use this design.

To our knowledge at this time, there is no such product or design currently on the market. Therefore, EnviroTime, Inc. (c/o William J. Bugg) is applying for a patent to protect our design and invention. We would like to claim this design as an original invention as shown on the attached drawings.

### BRIEF DESCRIPTION OF THE SEVERAL VIEWS OF THE DRAWINGS

FIG. 1.0—Front View of “The Drum Stick”:

This drawing depicts the front view of “The Drum Stick”. It displays the measurement for estimating the amount of liquid in a 55-gallon drum.

Proposed Dimensions:

Stick: 1½ inches wide×1/2 inch thick×45 inches long

Handle: 3½ inches wide×1/2 inch thick×7 inches long

Handle Hole: 1 inch wide×2 inches long

Liquid Measurement: 3¼ inches=5 gallons

FIG. 2.0—Back View of “The Drum Stick”:

This drawing depicts the back view of “The Drum Stick”. It displays the measurement for estimating the amount of liquid in a 30-gallon drum.

Proposed Dimensions:

Stick: 1½ inches wide×1/2 inch thick×45 inches long

Handle: 3½ inches wide×1/2 inch thick×7 inches long

Handle Hole: 1 inch wide×2 inches long

Liquid Measurement: 4½ inches=5 gallons

FIG. 3.0—Side View of “The Drum Stick”:

This drawing depicts the side view of “The Drum Stick”.

Proposed Dimensions:

Stick: 1½ inches wide×1/2 inch thick×45 inches long

Handle: 3½ inches wide×1/2 inch thick×7 inches long

### DETAILED DESCRIPTION OF THE INVENTION

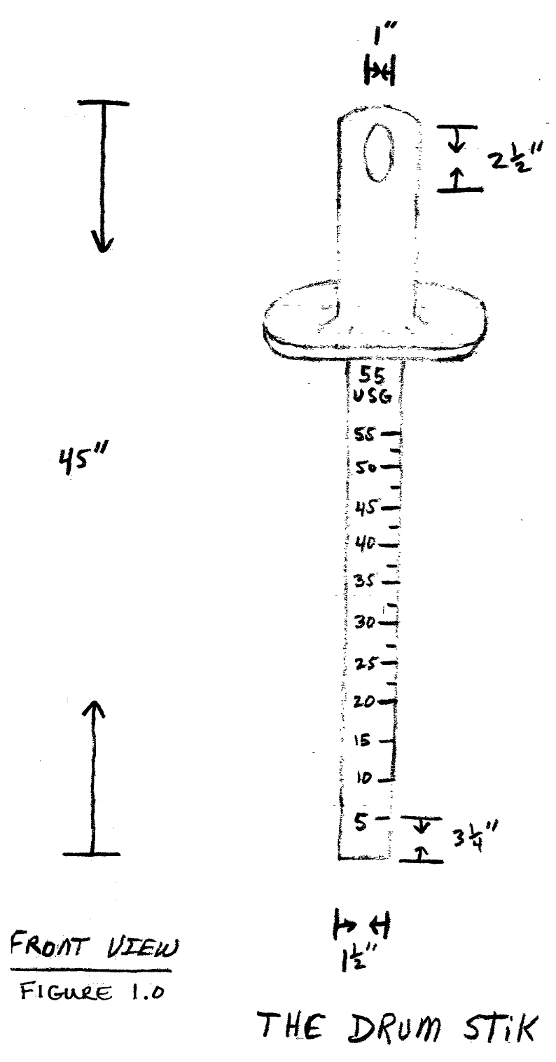

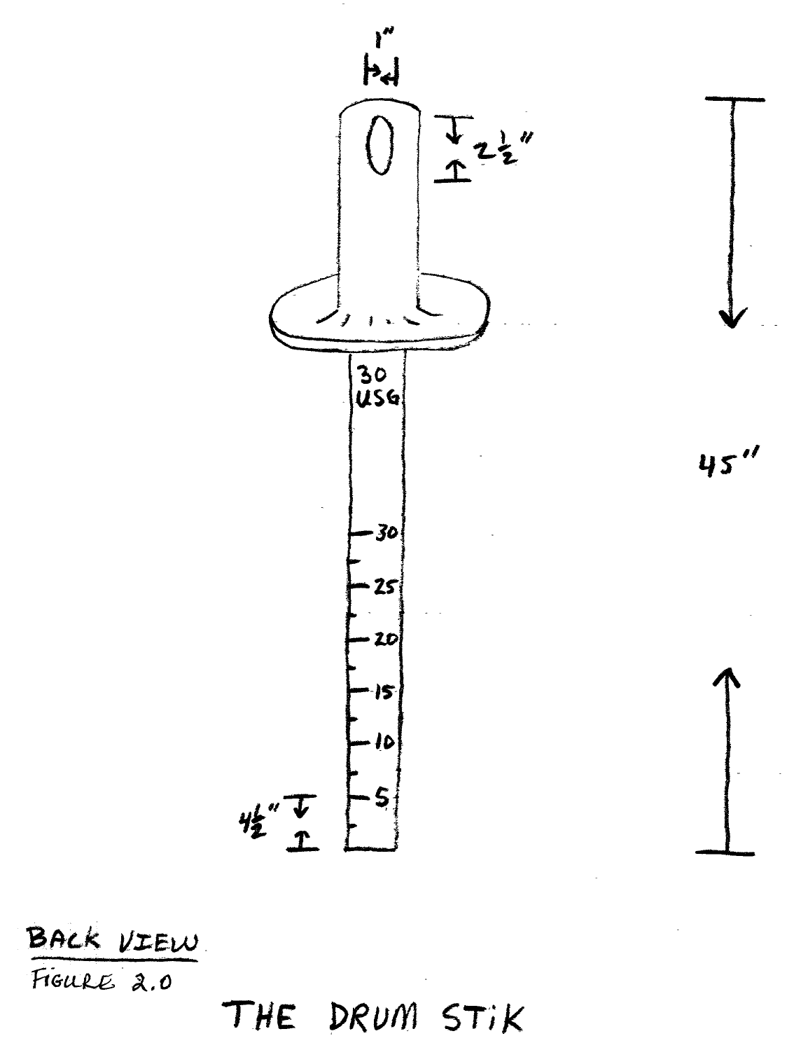

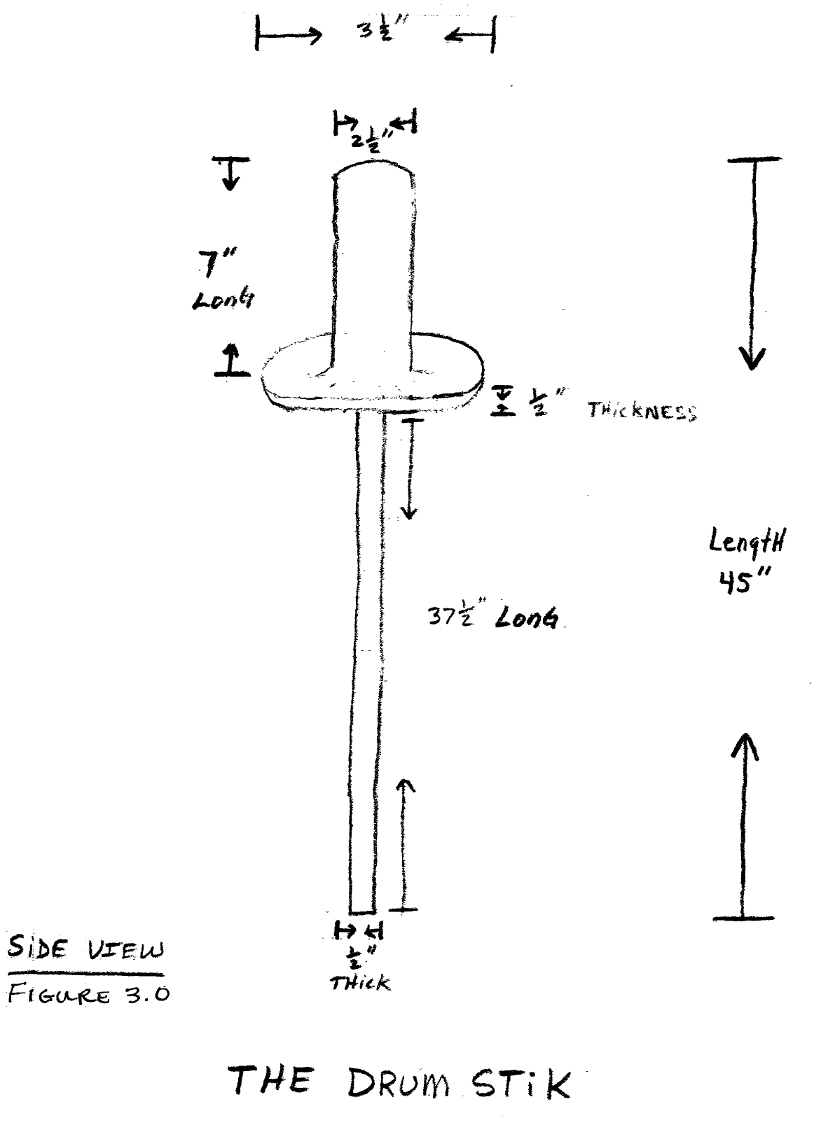

EnviroTime, Inc. (sole inventor: William J. Bugg) designed a new product that will assist the environmental industry and marketplace. The invention is a specialty designed product and we are claiming it under a patent to protect its uniqueness. The product has been designed and is in the manufacturing stages. We are currently designing the product as outlined above in Section 7.0. Attached are detailed design drawings (FIGS. 1, 2, and 3).

As stated above, the product is to provide hazardous and non-hazardous waste generators a tool for accurately measuring the amount of liquid waste prior to shipment offsite. The hole in the handle of “The Drum Stik” is so the customer can slide a rag through the end of the stick and wipe off the residual oil or liquid that accumulates on the stick during the measuring process.

The height of the liquid in the drum is captured in the notches on “The Drum Stik”, therefore, the level of the liquid can be read off of the notch on the stick. The notches are specifically calculated to coordinate with the typical dimensions of a standard 30-gallon and 55-gallon hazardous waste drum. Prior to a shipment of waste offsite for disposal, a generator can take more precise measurements, instead of relying on the waste hauler to estimate the volume.

1. What I claim as my invention is “the Drum Stik”—this invention is an original, unique tool for the environmental industry to adequately measure the amount of liquid material in a standard 30 or 55-gallon hazardous waste drum.
